(19) United States
(12) Patent Application Publication
(10) Pub. No.: US 2022/0185997 A1
(43) Pub. Date: Jun. 16, 2022

(54) BIOGRADABLE MATERIAL AND PREPARATION METHOD AND APPLICATION

(71) Applicant: Guangzhou University, Guangzhou (CN)

(72) Inventors: Shan HE, Guangzhou (CN); Yang ZHANG, Guangzhou (CN); Jingrong GAO, Guangzhou (CN)

(21) Appl. No.: 17/462,692

(22) Filed: Aug. 31, 2021

(30) Foreign Application Priority Data
Dec. 10, 2020 (CN) 202011435946.2

(51) Int. Cl. C08L 5/12; C08K 5/053; C08L 5/04

(52) U.S. Cl. CPC C08L 5/12; C08L 2201/06; C08L 5/04; C08K 5/053

(57) ABSTRACT

The disclosure provides a biodegradable material and its preparation method and application, which solves the problems of a harsh preparation condition of a biodegradable material, a rough surface on a film formed by the prepared biodegradable material, pores existing in a cross section. The biodegradable material of the present disclosure is high in preparation efficiency and simple in preparation process and energy consumption saving without necessary high-temperature and high-pressure conditions. There is no obvious difference between its degradation performance and the degradation performance of the biodegradable material prepared by the conventional high-temperature high-pressure method. The biodegradable material is suitable for preparing a film to be applied to a field of packaging materials. The prepared film may be completely degraded in about 15 days. The prepared film is smoother on surface and more excellent in toughness and malleability compared with the film prepared under conventional high-temperature and high-pressure conditions.

### TECHNICAL FIELD

The disclosure relates to a field of environmental protection material technologies, and particularly to a biodegradable material and its preparation method and application.

### BACKGROUND ART

Negative influences of plastic materials prepared by a conventional petroleum chemical approach on the environment is increasingly significant, and environmental pollution caused by plastic promotes a research on a degradable polymer.

Degradation of a polymer occurs primarily through breakage of a main chain or a side chain, specifically including thermal degradation reaction, oxidation reaction, photochemical degradation, radiation chemical degradation and hydration reaction. Degradation of some polymers occurs in a biological environment, such as around living cells or tissues. The biological environments include soil, oceans, rivers and lakes, and also includes in vivo environments of humans and animals.

A biodegradable polymer is a particular type of polymer that may be decomposed by bacteria after reaching its expected life to form products such as CO2, N2, water and minerals. The polymers are mainly composed of ester, amide and ether functional group.

At present, a biodegradable material is mainly prepared by high pressure thermal reaction. However, on one hand, the high pressure thermal reaction conditions are relatively harsh, on the other hand, a film formed by the prepared biodegradable material is rough on the surface, pores exist in a cross section after cutting and the malleability is poor.

### SUMMARY

The present disclosure is intended to at least solve one of technical problems existing in the related art. For this purpose, the disclosure provides a biodegradable material in order to solve the problems of a harsh preparation condition of a biodegradable material, a rough surface on a film formed by the prepared biodegradable material, pores existing in a cross section after cutting and a poor malleability in the related art.

The disclosure further provides a preparation method of the above biodegradable material.

The disclosure further provides an application of the above biodegradable material.

A first aspect of the disclosure provides a biodegradable material. The preparation raw materials include agar, alginate and glycerol, the mass ratio of the agar, the alginate and the glycerol being (0.2˜0.8):1:(0.2˜0.8).

In the preparation raw materials, commercially available alginate may be configured as a preparation raw material of the disclosure.

According to some embodiments of the disclosure, preparation raw materials of the biodegradable material include agar, alginate and glycerol, the mass ratio of the agar, the alginate and the glycerol being (0.2˜0.5):1:(0.2˜0.5).

According to one embodiment of the disclosure, the preparation raw materials of the biodegradable material in parts by weight include:

Agar: 0.5 part,

Alginate: 1 part,

Glycerol: 0.5 part,

Water: 100 parts.

A second aspect of the disclosure provides a preparation method of the above biodegradable material. The method includes the following blocks:

S1: mixing the agar, the alginate and the glycerol into water according to the ratio of the biodegradable material, and microwave heating to obtain a mixed liquid;

S2: drying the mixed liquid to obtain the biodegradable material.

Unlike a conventional heating method heating from outside to inside, microwave heating heats outside and inside simultaneously. Microwave transmits energy to the inside and outside of the heated substance uniformly and simultaneously to ensure heating inside and outside uniformly and simultaneously. The heating enables the raw materials of the biodegradable film to react more completely during preparation, and the intermolecular covalent bonds are connected to each other more closely, so that the mechanical strength of the biodegradable film is significantly improved.

According to some embodiments of the disclosure, at block S1, the power of the microwave condition is 60˜120 Hz.

According to some embodiments of the disclosure, at block S1, the power of the microwave condition is 80˜100 Hz.

According to some embodiments of the disclosure, at block S1, the power of the microwave condition is 100 Hz.

According to some embodiments of the disclosure, at block S1, the heating temperature is 60˜100° C.

According to some embodiments of the disclosure, at block S1, the heating temperature is 80˜100° C.

According to some embodiments of the disclosure, at block S1, the heating temperature is 80° C.

According to some embodiments of the disclosure, at block S1, the heating time is 20˜40 min.

According to some embodiments of the disclosure, at block S1, the heating time is 30 min.

According to some embodiments of the disclosure, at block S2, the drying temperature is 30˜50° C.

According to some embodiments of the disclosure, at block S2, the drying temperature is 45° C.

According to some embodiments of the disclosure, at block S2, the drying time is 10˜30 h.

According to some embodiments of the disclosure, at block S2, the drying time is 20 h.

A third aspect of the disclosure provides a biodegradable film. The biodegradable film includes the above biodegradable material or is prepared by the above method.

According to some embodiments of the disclosure, the thickness of the biodegradable film is 50˜150 m.

According to some embodiments of the disclosure, the malleability of the biodegradable film is significantly improved without reducing the biodegradability.

The biodegradable material of the disclosure at least has the following beneficial effects:

The biodegradable material of the disclosure is high in preparation efficiency and simple in preparation technologies and energy consumption saving without necessary high-temperature and high-pressure conditions. There is no obvious difference between its degradation performance and the degradation performance of the biodegradable material prepared by the conventional high-temperature high-pressure method.

The biodegradable material is suitable for preparing a film to be applied to a field of packaging materials. The prepared film may be completely degraded in about 15 days.

The biodegradable material is suitable for preparing a film to be applied to a field of packaging materials. The prepared film is smoother in surface and more excellent in toughness and malleability compared with the film prepared under conventional high-temperature and high-pressure conditions.

### BRIEF DESCRIPTION OF THE DRAWINGS

FIG. 1 is an engineering stress-strain curve of biodegradable films prepared in Embodiment 1 and Contrast Embodiment 1.

FIG. 2 is a schematic diagram of a surface microstructure of a biodegradable film prepared in Embodiment 1.

FIG. 3 is a schematic diagram of a microstructure of a biodegradable film prepared in Contrast Embodiment 1.

FIG. 4 is a schematic diagram of an edge microstructure of a biodegradable film prepared in Embodiment 1.

FIG. 5 is a schematic diagram of an edge microstructure of a biodegradable film in Contrast Embodiment 1.

FIG. 6 is a schematic diagram of contact angles of biodegradable films prepared in Embodiment 1 and Contrast Embodiment 1.

### DETAILED DESCRIPTION

The followings are specific embodiments of the disclosure and a further description in combination with the technical scheme, however, the embodiments are not limited in the disclosure

### Embodiment 1

A biodegradable film is prepared. The specific preparation process is:

S1: mixing 2.5 g agar, 5 g alginate and 2.5 g glycerin in 500 mL water, and heating at 100 Hz microwave power in a microwave equipment at 80° C. for 30 min to obtain a mixed liquid;

S2: pouring the mixed liquid obtained at block S1 into a 20 cm×30 cm tray, and drying in an oven at 45° C. for 20 h to form a film with a thickness of 100 μm.

### Embodiment 2

A biodegradable film is prepared. The specific preparation process is:

S1: mixing 1 g agar, 5 g alginate and 1 g glycerin in 500 mL water, and heating at 100 Hz microwave power in a microwave equipment at 80° C. for 30 min to obtain a mixed liquid;

S2: pouring the mixed liquid obtained at block 51 into a 20 cm×30 cm tray, and drying in an oven at 45° C. for 20 h to form a film with a thickness of 100 μm.

### Embodiment 3

A biodegradable film is prepared. The specific preparation process is:

S1: mixing 4 g agar, 5 g alginate and 4 g glycerin in 500 mL water, and heating at 100 Hz microwave power in a microwave equipment at 80° C. for 30 min to obtain a mixed liquid;

S2: pouring the mixed liquid obtained at block S1 into a 20 cm×30 cm tray, and drying in an oven at 45° C. for 20 h to form a film with a thickness of 100 μm.

### Contrast Embodiment 1

A biodegradable film is prepared by a conventional high-temperature and high-pressure method. The specific preparation process is:

S1: mixing 2.5 g agar, 5 g alginate and 2.5 g glycerin in 500 mL water, and heating in a high-pressure reactor with a 3 bar pressure at 120° C. for 30 min to obtain a mixed liquid;

S2: pouring the mixed liquid obtained at block 51 into a 20 cm×30 cm tray, and drying in an oven at 45° C. for 20 h to form a film with a thickness of 100 μm.

### Test Embodiment 1

The embodiment tests the degradation performance of the biodegradable films prepared in Embodiment 1 and Contrast Embodiment 1.

The test method is: cut a film into about 150 g 25 mm×25 mm squares, soak in water for 3 min, and then soak in 96% ethanol for 2 min. Dry the film at room temperature for 16 h after soaking, and weigh for a first time after drying. Place the film in a container with 200 mg soil for 30 days after weighing. Take out a film once every 5 days to record the weight loss of a film. The result is as illustrated in Table 1.

TABLE 1
Test Results of Film Weight Loss

| | Weight Loss of Film (%) | |
|---|---|---|
| | Film Prepared in | Film Prepared in |
| Days | Contrast Embodiment 1 | Embodiement 1 |
| 5 days | 28.01 ± 3.02 | 27.43 ± 0.49 |
| 10 days | 58.23 ± 2.63 | 57.63 ± 0.65 |
| 15 days | 98.65 ± 1.23 | 97.93 ± 0.98 |
| 20 days | 98.93 ± 0.54 | 99.10 ± 1.20 |
| 25 days | 99.10 ± 1.20 | 98.21 ± 0.93 |
| 30 days | 99.20 ± 0.13 | 99.10 ± 0.33 |

As can be seen from Table 1, the biodegradability of the film prepared in Embodiment 1 is not reduced. The films prepared in Contrast Embodiment 1 and Embodiment 1 are completely degraded in about 15 days.

### Test Embodiment 2

The embodiment tests the mechanical performance of the biodegradable films prepared in Embodiment 1 and Contrast Embodiment 1.

The test method is:

A uniaxial tensile test. Do test at room temperature. The device is an Instron 5960 universal testing machine with a weighing sensor with a capacity range of 500N. The loading rate is constant at 5 mm/min, and displacement and loading values are recorded from a test system. The sample length between rigid pinches is designated as 60 mm. The sample is fixed on a digital caliper with a 20 mm width and about 0.1 mm thickness for test.

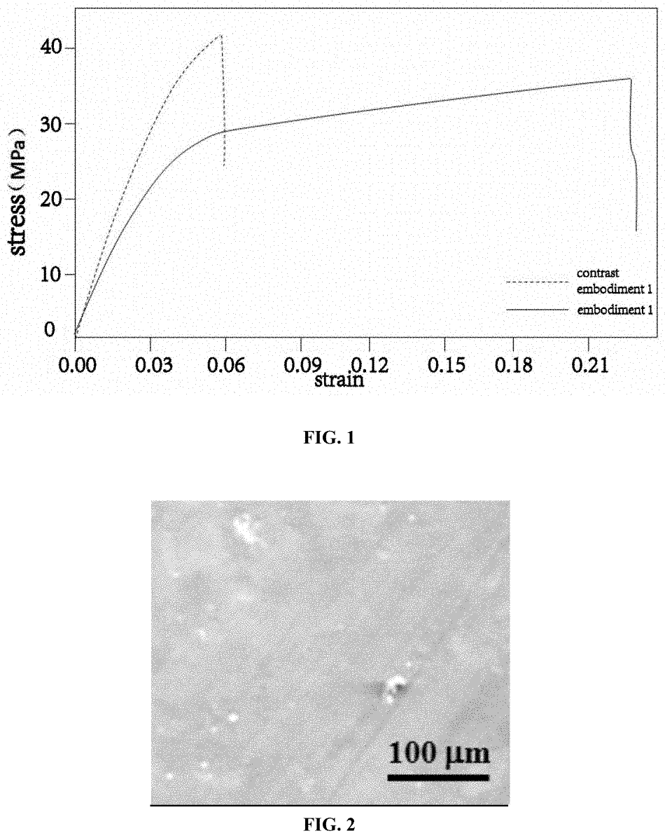

The engineering stress-strain curve of biodegradable films prepared in Embodiment 1 and Contrast Embodiment 1 refers to FIG. 1.

FIG. 1 reflects a stress strain relationship in a film deformation process. In which, a stress-strain value represents brittleness and malleability of the tested material. As can be seen from FIG. 1, comparing the film of Embodiment 1 with the film of Contrast Embodiment 1, in the preparation method of Embodiment 1, the mechanical strength of the film is significantly improved, the brittleness of the film is reduced from 40 MPa to 37 MPa, and the malleability increases from 0.04% to 0.15%. In Embodiment 1, microwave heating heats from inside to outside simultaneously. Microwave may transmit energy to the inside and outside of the heated substance uniformly and simultaneously, and the material inside and outside is heated uniformly and simultaneously. The heating method makes the preparation raw materials of the biodegradable film react more completely and connected to each other more closely, therefore, the mechanical strength of the biodegradable film in Embodiment 1 is significantly improved.

### Test Embodiment 3

The embodiment observes microstructures of the biodegradable films prepared in Embodiment 1 and Contrast Embodiment 1 through an FEI-F50 type scanning electron microscope (SEM).

The facula size is 2.0 and the voltage is 5.0 kV. The preparation method of an SEM sample is: immersing a film in liquid nitrogen for 2 min, cutting the film into 5 mm×5 mm×2 mm (L×W×T) slices with a scalpel, and then plating a 2 nm thickness coating on the surface of the sample with a platinum sputtering method.

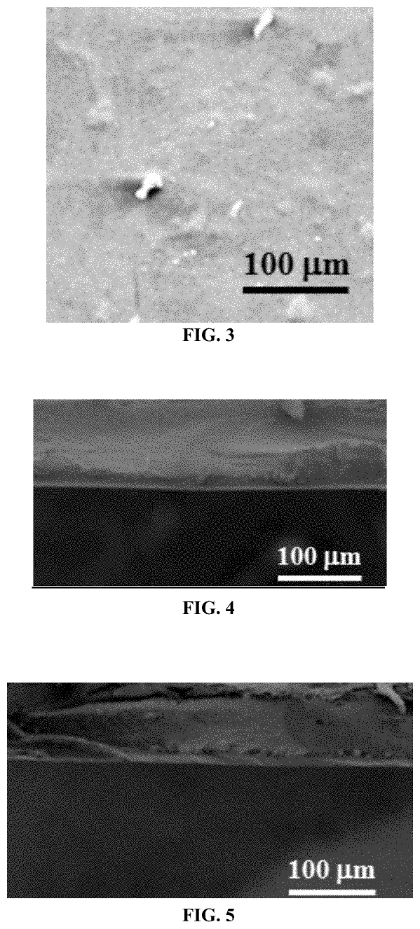

The surface microstructure of a biodegradable film prepared in Embodiment 1 is as illustrated in FIG. 2, and the microstructure of a biodegradable film prepared in Contrast Embodiment 1 is as illustrated in FIG. 3. The edge microstructure of a biodegradable film in Embodiment 1 is as illustrated in FIG. 4, and the edge microstructure of a biodegradable film in Contrast Embodiment 1 is as illustrated in FIG. 5.

By comparing FIG. 4 with FIG. 5, it can be seen that there are large differences between edges of biodegradable films prepared by the two methods. It is observed that the edge of the biodegradable film prepared in Contrast Embodiment 1 has a hollow internal structure with cracks, and the edge of the biodegradable film prepared in Embodiment 1 is a completely filled solid brick structure without any cracks. Microwave heating is efficient in strong micromixing oriented in one direction, and crosslinking materials may be crushed into smaller sizes and arranged in one direction. In contrast, materials processed by the conventional high-temperature and high-pressure method are randomly arranged and non-uniform in direction, resulting in cracks in the hollow inner edge structure.

Unlike a conventional heating method heating from outside to inside, microwave heating heats outside and inside simultaneously. Microwave transmits energy to the inside and outside of the heated substance uniformly and simultaneously to ensure the materials heated inside and outside uniformly and simultaneously. The heating makes raw materials of the biodegradable film react simultaneously without delay during preparation, therefore, the surface of the biodegradable film prepared in Embodiment 1 is regular, flat and distributed in one direction with clear stripes. However, since the conventional heating method heats from outside to inside and heat transfer delay is obvious, the raw materials of the biodegradable film may not react simultaneously during preparation, and the surface of the prepared biodegradable film is irregular, rough and without regular stripes.

### Test Embodiment 4

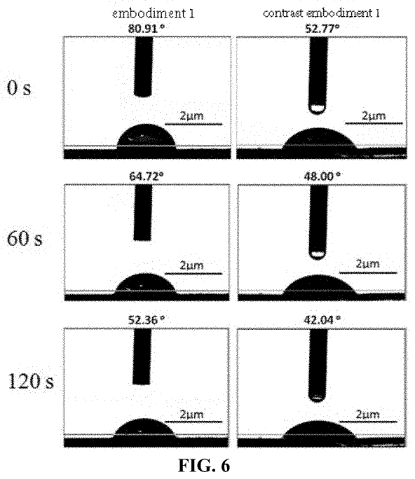

The embodiment tests contact angles of biodegradable films prepared in Embodiment 1 and Contrast Embodiment 1. The result is as illustrated in FIG. 6.

The test method is: testing a contact angle with a standard Rame Hart 250 angle gauge under ambient conditions (22° C.), and recording with a DROP Image Advanced V2.8 software. For a fixed drop technique, 5-7 μL water drop is deposited on the substrate and a contact angle is tested within 5 s. For a bubble capture method, a bubble with a volume of 64, is provided at an interface with a back stitch (28 gauge, 304 stainless steel Rame Hart). The contact angle in the video is analyzed with an Image J (Drop snake analysis) software.

The contact angle of each layer of film is tested 3 times at 0 s, 60 s, and 180 s. The contact angle of the biodegradable film prepared in Embodiment 1 is changed from 80.91° to 52.36°. The contact angle of the biodegradable film prepared in Contrast Embodiment 1 is changed from 52.77° to 42.04°, and in each test, the contact angle of the biodegradable film prepared in Embodiment 1 is higher than that of the biodegradable film prepared in Contrast Embodiment 1. The surface roughness has a large impact on the contact angle. The more uniform the surface is, the smaller the wettability caused by the surface chemical property is, the greater the contact angle is.

The disclosure is described with reference to the embodiments, however, the disclosure is not limited to the above embodiments and various changes may be made without departing from the spirit of the disclosure.

1. A biodegradable material, wherein, preparation raw materials of the biodegradable material comprising agar, alginate and glycerol, the mass ratio of the agar, the alginate and the glycerol being (0.2-0.8):1:(0.2-0.8).

2. The biodegradable material of claim 1, wherein mass ratio of the agar, alginate and glycerol in the preparation raw material is (0.1-0.5):1:(0.1-0.5).

3. A method for preparing a biodegradable material, comprising:
mixing agar, alginate, and glycerol in preparation raw materials into water and microwave heating to provide a mixed liquid, wherein a mass ratio of the agar, alginate, and glycerol is (0.2-0.8):1:(0.2-0.8); and
drying the mixed liquid to obtain the biodegradable material.

4. The method for preparing a biodegradable material of claim 3, wherein a power of the microwave heating is 60-120 Hz.

5. The method for preparing a biodegradable material of claim 3, wherein a temperature of the microwave heating is 60-100° C.

6. The method for preparing a biodegradable material of claim 3, wherein, the time of a duration of the microwave heating is 20-40 min.

7. The method for preparing a biodegradable material of claim 3, wherein, a drying temperature is 30-50° C.

8. The method for preparing a biodegradable material of claim 3, wherein a duration for the drying is 10-30 hours.

9. (canceled)

10. The method for preparing a biodegradable material of claim 3, wherein the mass ratio of the agar, alginate, and glycerol is (0.1-0.5):1:(0.1-0.5).
